(19) United States
(12) Patent Application Publication
(10) Pub. No.: US 2006/0043733 A1
(43) Pub. Date: Mar. 2, 2006

(54) Fit peanut fitting for containers of heat exchangers

(76) Inventors: Hanskarl Hoffmann, Koeln (DE); Bernhard Mueller, Niederzier (DE)

Correspondence Address: VISTEON, C/O BRINKS HOFER GILSON & LIONE, PO BOX 10395, CHICAGO, IL, 60610, US

(21) Appl. No.: 11/193,823

(22) Filed: Jul. 29, 2005

(30) Foreign Application Priority Data
Jul. 29, 2004 (DE) 10 2004 038 079.1

(51) Int. Cl. F16L 41/00

(52) U.S. Cl. 285/202

(57) ABSTRACT

The invention relates to a fit peanut fitting for containers of heat exchangers and provided for connecting the containers to a connection tube for feeding or draining a heat-transmitting, passing medium. The fit peanut fitting includes a main piece and an accompanying insert portion, whereby the main piece on one end contains a seating portion for receiving the connection tube and on the opposite end includes a stop surface being conformal with the container's outer wall surface. A passage channel passes from the seating portion to the insert portion and provides for the passing medium, whereby the insert portion projects beyond the stop surface such that at least a fixing connection to the wall opening of the container is achievable.

### BACKGROUND

1. Field of the Invention

The invention relates to a fit peanut fitting for containers of heat exchangers provided for the connection of the container to a connection tube for feeding or draining of a heat-transmitting, passing medium.

2. Related Technology

The traditional containers of the heat exchangers, also referred to as tanks or headers, are connected to the outer connection tubes, which are feeding and/or draining tubes for refrigerants, for example, by means of connection elements, particularly peanut fittings.

In the vehicle industry, the peanut fittings are used for the fast connection of the heat exchanger and the connection lines. A traditional peanut fitting includes a seating plug-in portion and an insert plug-in portion with, as a rule, the seating plug-in portion connected to the connection tube and the insertion plug-in portion connected to the container. The peanut fittings located at the heat exchanger are brazed to the container using rivets. The rivets also function as provisional holding elements prior to brazing, which is provided as the final fastening connection and the proper sealing connection. In order to carry out the preliminary fixing of the peanut fitting to the container by at least one rivet, not only are the wall openings for the connection lines are required at the container, but also rivet holes.

Due to the provision of the additional holes and of the rivets, the strength of both the container and the peanut fitting may be reduced. Rivets deteriorate the strength properties of the container and lead to critical stress spots. For a normal internal pressurization of the container, peak stresses can occur that under extreme pressure loading can lead to cracks. In addition, rivets are costly in that the necessary fastening process results in high costs. From technological and economic points of view, rivets are a weak point within the whole connection.

Because of the weak points due to the rivets, in many cases additional holding elements for the connection tubes are provided at the container, or between the connection tubes, respectively, such as the insertion of a straight or bent tube between the container and the connection element. Mounting of the connection tube lines, bending of the connection tubes, and additional dipping of the connection element, all result in additional costs.

Another traditional assembly method of the peanut fittings consists of a straight or bent additional tube brazed between the peanut fitting and the container. In addition, in most cases a holding device is provided by means of which the peanut fittings is fastened to the container in such a way that the whole connection between container, peanut fitting and connection line, will withstand the stresses during the vehicle operation.

Further, another traditional assembly method fixes the position of the peanut fitting fixed at the container using welding points, prior to brazing of the container of the heat exchanger. This assembly method causes additional costs for welding.

In U.S. Pat. No. 1,583,758 a design of a boiler is described in which a connection tube is pushed into and connected to a head plate, which is bent to a container tube and provided with a hole for a connection tube. The connection tube has a tapering end portion fitting into the head plate hole. After insertion into the heat plate hole, the tapering end portion is flanged and, at the same time, welded to the hole edges by a stamping device and a tube holding device, both designed to function as an electrode. Then the head plate is bent to a container tube, whereby external flange hooks at the head plate are held by a hooking internal mating holding device. After external brazing of the contact slot of both butting flange hooks, a connection of the connection tube to the container tube is achieved.

A problem with the above is that for relatively small loads acting on the connection tube, the flange welded by the electrodes can tear causing the connection tube to become leaky.

In U.S. Pat. No. 1,988,158, tubing of a vapor boiler of an oil distillation apparatus is disclosed where the ends of two connection tubes—a feeding tube and a draining tube—are inserted into holes present in a connecting hollow bracket, with the ends of the connection tubes being expanded onto the internal hold edges to achieve sealing.

A problem with the above is that when the connection tubes are loaded, the connection between the internal hole edges and the matching range of the tube ends can disjoint.

In U.S. Pat. No. 2,266,611 a connection for glazed containers is described where a connection piece, provided with an internal thread and with a flange, is inserted into a hole present in the container wall. The portion of the inserted connection piece that extends into the interior of the container is, outside of the thread at the end side, provided with a tapered edge over which a sealing ring, or a washer, and a mating flange are pushed. In order to press the mating flange onto the sealing ring in a holding manner, the tapered edge is expanded at the connection piece, whereby the tapered edge by its pressure contact to the mating flange retains the connection piece in the container wall.

A problem with the above is the extreme difficultly in expanding the tapered edges from the interior of the tube in such a way that total sealing of the inserted connection piece will be achieved. In addition, the strength of the connection piece at the container wall is questionable.

In U.S. Pat. No. 5,067,235, a method for the connection of heat exchanger tubes, particularly flat tubes, to the head portion of the collecting container is described. The head portion is provided with a plurality of elliptic holes in which the flat tubes, with the heat transmitting ribs located between them, are clamped. The end regions of the flat tubes that are to be inserted into the elliptic holes are laterally shortened such that, after expanding of the rim and laying of the flat tube rim against the head portion, a brazeable connection is created.

A problem with the above is that while the ribs located between the flat tubes hold the flat tubes to a certain degree, the brazed rim can become loose under the loads applied to the head portion.

In U.S. Pat. No. 6,029,348, an oil cooler system and a method for its production are described. The oil cooler is provided with end-side holding parts to be used for the insertion and fastening of the oil cooler in an additional square-section encasement. The end-side holding parts are placed around insertion holes provided for oil feeding/intake and draining/outtake in which the tube connection pieces are inserted and held. The encasement also has two wider through holes, through which the holding parts are pushed from the interior outwards. The holding parts are provided with a washer and accompanying projections positioned on a circle, that after pushing through the through holes, extend the oil cooler onto the encasement. A sleeve disk is put over the circularly positioned projections and the tube connection piece is pushed into the insert holes of the oil cooler. The circularly positioned projections are thereafter radially bent outwards over the sleeve disk, which is provided to support holding of the tube piece, and, due to the arc shape, additionally hold the tube connection piece.

A problem with this construction is that despite of the reinforcing measures in the connection region of the tube connection piece at the oil cooler positioned in the interior, the connection region is very sensitive to external loads acting on the tube connection piece. In addition, the effort for reinforcement is directed to the wall reinforcement of the encasement rather than to secure the holding of the tube connection piece.

Further, in 2003/0080554 A1 a block peanut fitting for CO₂ air conditioning systems is described. The block peanut fitting is structured as a line connection consisting of two continuous blocks—a seating block and an insert block—secured to each other by screwing and also of seals provided to prevent CO₂ from escaping at high pressures and high temperatures, whereby the line connection is provided to connect two tubes positioned axially to each other. The insert block has a first through channel with a first end and a second end, whereby the first end seats a tube line end of a tube and the second channel end has an annular recess. The seating block also has a through channel with a first and a second end for the plug-in portion of the insert block, whereby the first end seats the line end of the other tube and at the opposite end, the seating block expands into an annular socket that surrounds the channel. An annular hole of the insert block seats a socket of the seating block, whereby the inner plug-in portion is inserted into the socket. Between them, at least one sealing element is provided.

Both blocks include an inner through passing channel and can be connected to each other by means of a screw connection laterally spaced from the two tube lines connected in straight run.

It is common to all described connection pieces, which are mounted to containers for the fastening of connection tubes, that they involve an increased risk of failure under loaded conditions of the connection tubes.

### SUMMARY OF THE INVENTION

The invention is meant to solve the problem of providing a fit peanut fitting for the containers of heat exchangers that is designed to enable the fit peanut fitting, or at least a portion of it, to be fixable to the container so as to ensure the seating of the fit peanut fitting at the container during the production steps from assembly to brazing.

The fit peanut fitting includes at least a main piece and an accompanying insert portion. The main piece has a seating portion for the connection tube, which is insertable into it in a matching manner. On the opposite end, a stop surface, conformal with the outer wall surface of the container, is provided and contains a passage channel passing from the seating portion to the insert portion. The insert portion projects past the stop surface such that at least a fixing connection to the wall-open container is achievable.

The projecting insert portion can be structured by means of either a sleeve arrestable in the passage channel and projecting over the stop surface or an insert projection formed at the stop surface and extending the passage channel.

The seating portion of the main piece on the one hand, and the stop surface with the accompanying channel-extending insert portion on the other hand, are by their end faces opposite to each other and each form the connection end regions of the fit peanut fitting. The seating portion has a recess for the insertion of the end region of the connection tube.

The channel-extending insert portion accompanying the main piece, summarizing, can optionally be designed and form connections at least as follows: as a sleeve expanded or flared on both ends to form a tulip or flange in the main piece and expanded to form a tulip or flange in the container; as a sleeve in a press fit engagement in the main piece and expanded or flared on the end to form a tulip or flange in the container; as a sleeve expanded or flared on the end to form a tulip or flange or in a press fit in the main piece and in a press fit in the container at the container wall opening; and as an insert projection formed at the main piece and a press fit at the container wall opening and/or expanded or flared to form a tulip or flange in the container.

The insert portion can be designed as a part separate from the main piece, in form of the sleeve with the sleeve being formfittingly insertable into a fit passage of the passage channel.

The fit passage, depending on the design of the passage channel, can be a channel extending from the recess to the stop surface, can be a channel extending from an intermediate chamber in the main piece to the stop surface or can be a radially expanded channel in which the sleeve is pressed in a press fit for fastening. In this case the fit peanut fitting substantially consists of the main piece and the sleeve insertable into the main piece whereby the sleeve has a longer length than the fit passage.

Two connections—a double connection—can be obtained by means of the sleeve, whereby the double connection can consist, on the one hand, of the connection between the sleeve and the main piece and, on the other hand, the connection between the sleeve and the container.

The main piece can include the seating portion present in the end region away from the container (designed suitable for the insertable connection tube), the subsequent fit passage and the stop surface present in the end region near to the container conformal with the container outer wall.

Optionally, an intermediate chamber can be present between the seating portion and the fit passage. In this case, the sleeve is inserted into the fit passage and projects partly into the intermediate chamber over the end portion and is structured to retain itself there by means of tulip-shaped expansions, flares or flanges. The sleeve projects, on the other end, over the top surface with its end portion as an insertion portion.

In case of the radially expanded channel, the sleeve can be inserted formfittingly into the fit passage or can be radially expanded and press fit in order to achieve a formfitting and force-transmitting contact to the inner surface of the fit passage.

Further, the main piece can also be divided into two body elements. Particularly, the seating portion of the main piece can be structured as a separate part relative to a main piece's remaining body. The accompanying connection region between both parts can be provided with a seating opening of the main piece's remaining body and an insertion member of the seating portion body. Prior to the assembly of the fit peanut fitting, the connection tube can be put into the recess of the seating portion body with the insertion member and be firmly held there. A fixed connection of the connection region can then be achieved by a screwing connection between the seating portion body and the main piece remaining body. Preferably, the seating opening has the dimensions of the recess. The fit peanut fitting can therefore be designed in several parts with the main piece serving as a supporting holding part and the insertion part preferably provided as a holding part.

The passage channel in the interior can be provided with at least two spaces, with the recess of the seating portion for the insertable connection tube and fit passage being the two passage spaces of the passage channel. Preferably, in this case the recess has a wider inner diameter compared to the fit passage.

The passage channel can also have three or more partial spaces located following each other, inclusive of both external hollow-cylindrical partial spaces (the recess and the fit passage) with different diameters, whereby a central partial space is located between the recess and the fit passage as an intermediate chamber. The intermediate chamber can be provided with a tapering inclination shaped, as a truncated cone or a rectangular shoulder, directed to the fit passage, whereby a rectangular shoulder also exists between the recess and the intermediate chamber and the recess has a wider diameter than the intermediate chamber. The sleeve has a length longer than the length of the hollow-cylindrical fit passage and extends the passage channel into the container. Therefore, the sleeve is provided on both ends with end portions projecting over the length of the fit passage and is inserted into the fit passage. On one end, the projecting portion of the sleeve end can be expanded to form a tulip, or flanged, at the inclination or at the shoulder of the intermediate chamber or the recess for holding. On the other end, it can be flanged over—expanded to form a tulip—at the end portion projecting into a wall opening of the container for holding it at the inner wall of the container. Due to the respective expansions, or flangings, respectively tulips or flanges of the projecting end portions, press fit connections, which are present as a first socket in the border region between the intermediate chamber/recess and the fit passage and as a second socket at the inner container wall can form a double connection.

The invention allows for a construction without fixing rivets. With the present invention, the fit peanut fitting is fastened at a given position to the container of the heat exchanger without deteriorating the strength properties (e.g., resistance to bursting pressure, strength, stress) of the container.

In the heat exchanger, the container can be designed as a container tube, a collector tube, a head piece, a tank, etc. Optionally, flat tubes or microchannel tubes, with fins for heat transmission between them, can be positioned between two containers.

### BRIEF DESCRIPTION OF THE DRAWINGS

The invention is explained in greater detail by means of some embodiments with reference to the following drawings in which:

FIG. 1 is a schematic side view of a fit peanut fitting according to the invention between a connection tube and a container;

FIG. 2 is a sectional view of the fit peanut fitting in contact with the container, seen from the top, without flaring of the sleeve end portions, and generally taken along the line I-I of FIG. 1;

FIG. 3 is a sectional view, generally along the line I-I of FIG. 1, of the fit peanut fitting in contact with the container seen with the holding deformation of the sleeve end portions to form flanges;

FIG. 4 is a sectional view of the main piece of the fit peanut fitting with a press fit provided for the sleeve;

FIG. 5 is a sectional view of the main piece of the fit peanut fitting with a sleeve in a press fit engagement in the passage channel and with end portion projecting into the container;

FIG. 6 is a sectional view of the main piece in FIG. 5 with the projecting end portion expanded to form a tulip;

FIG. 7 is a sectional view of a main piece, similar to FIG. 5, without the projecting end portion projecting far into the container, but with the sleeve in press fit in the fit passage and in the container wall hole;

FIG. 8 is a sectional view of a main piece with an insert projection formed at one end of the main piece;

FIG. 9 is a sectional view of a main piece with an insert projection (formed at one end of the main piece) a press fit at the container wall hole;

FIGS. 10a and 10b are, respectively, a sectional view of main piece, with a simplified shape having a seating portion and fit passage, and an associate top view to the seating portion;

FIG. 11 is a sectional view of the main piece of FIG. 10 joined to a container and having a press fit sleeve and with one expanded to form a tulip at the inner container wall; and

FIG. 12 is a sectional view of a main piece having a seating portion body connected to a main piece remaining body, and with a sleeve having a tulip-expanded connection at both the main piece and the container.

### DETAILED DESCRIPTION

Throughout the various figures and the description that follows, like elements of the embodiments are designated with the same reference numerals.

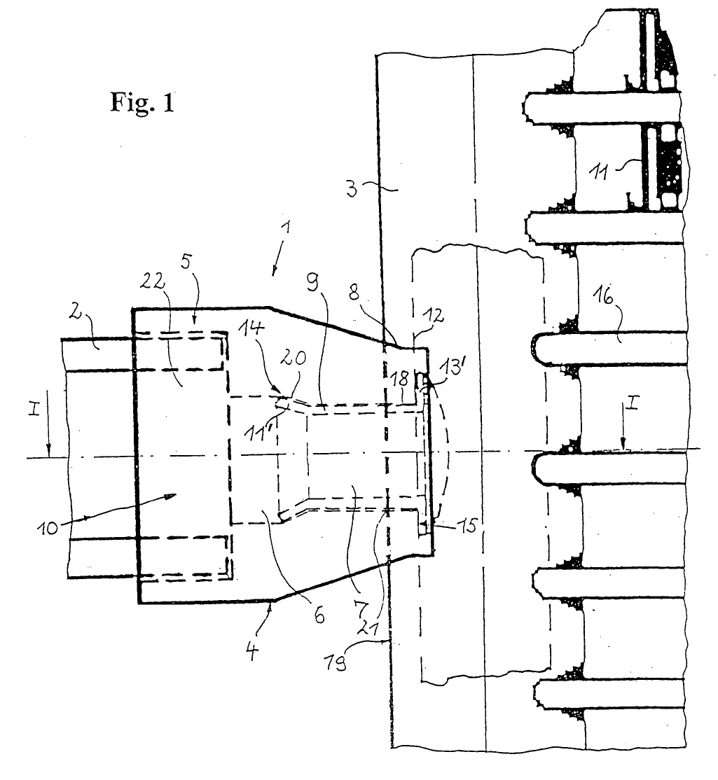

Referring now to FIGS. 1, 2 and 3, shown therein a fit peanut fitting 1 that is provided for the connection between the containers of heat exchangers and a connection tube 2 for feeding and draining a heat-transmitting, passing medium passing therethrough.

According to the invention the fit peanut fitting 1 includes at least a main piece 4 and an accompanying insert portion 9, whereby the main piece 4 on the one end has a seating portion 5, for receiving a connection tube 2 insertable into it, and on the opposite end has a stop surface 8 conformal with an outer wall surface 19 of the container 3. The main piece 4 also contains a passage channel 10 passing from the seating portion 5 to the insert portion 9, provided for the passage medium. The insert portion 9 projects over the stop surface 8 such that at least a fixing connection 15 to the inner wall surface adjacent to the wall opening 18 of the container 3 is achievable.

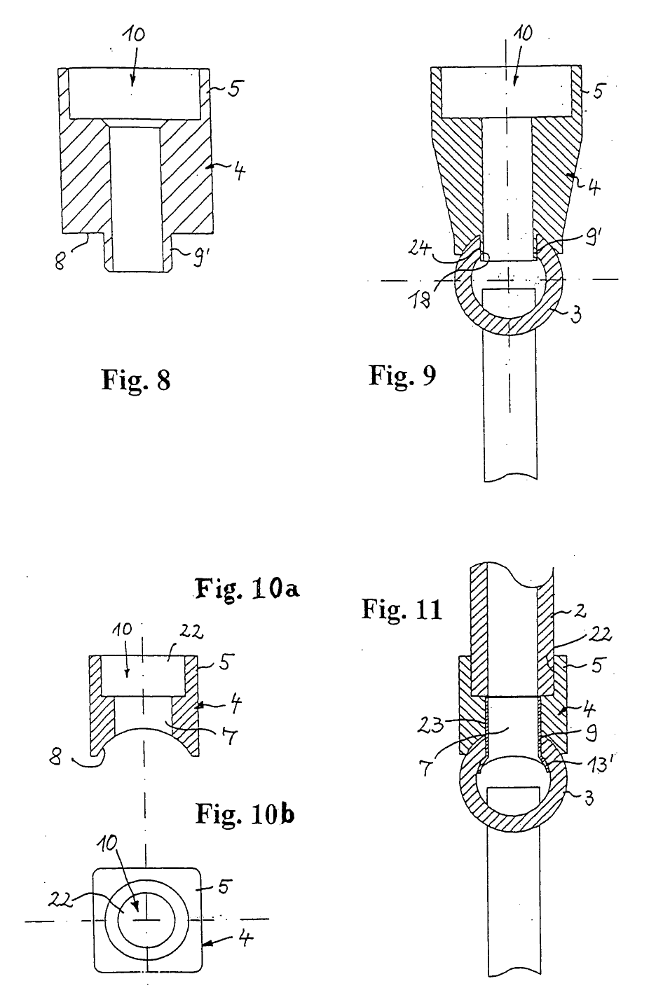

The insert portion 9 can be designed as either a sleeve, FIGS. 1-3, 5-7, 11 and 12, arrestable in the passage channel 10 projecting over the stop surface 8 or as an insert projection 9′, as seen in FIGS. 8 and 9, formed projecting from the stop surface 8.

The passage channel 10, as seen in FIG. 1 includes, beginning from the end away from the container, the recess 22 provided for the insertable connection tube 2, the subsequent intermediate chamber 6 and a following fit passage 7 that ends at the stop surface 8. The recess 22 in the seating portion 5 has a wider diameter than the intermediate chamber and the fit passage 7 has the narrowest diameter. The intermediate chamber 6 is provided with a tapering inclination, or taper 20, shaped as a truncated cone, directed to the fit passage 7. The insert portion 9, herein a sleeve, provided in the fit passage 7 has a length longer than the length of the fit passage 7.

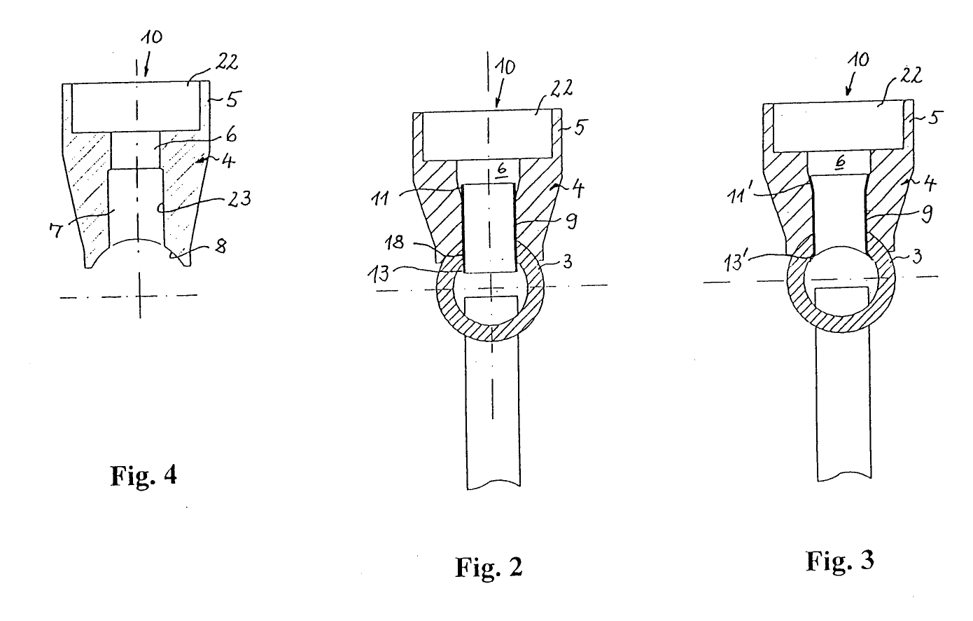

As FIG. 2 shows, the sleeve 9 is inserted formfittingly into the fit passage 7 and the wall opening 18. On the one end, the sleeve 9 projects into the intermediate chamber 6 and, at the taper 20, forms a structured holding portion by expansion of the end portion 11′, as seen in FIG. 1 and FIG. 3. On the other end, the sleeve projects with its end portion 13 beyond the stop surface 8. With its end portion 13, projecting in FIG. 2, over the stop surface 8, the sleeve 9 is an insert portion, insertable into the wall opening 18 and is flared or flanged, in the FIGS. 1, 3, at the inner wall 12 of the container 3.

Due to the respective holding expansions or flangings 11′, 13′ of the projecting end portions 11, 13, a first socket 14 (designated in FIG. 1) is formed in the border region between the tapering intermediate chamber 6 and the fit passage 7 and a second socket 15 (designated in FIG. 1) is formed at the container inner wall 12.

The sleeve 9 can also have a such a length that when no intermediate chamber 6 is present and it projects with its end portion into the rectangular recess 22 and can be expanded by means of a tool (or the inserted connection tube) to form a collar for internal arresting.

With the sleeve 9 shown in FIG. 1, a double connection 14, 15 at the end portions opposing each other is achieved, one end connection being formed from the expanded flaring of the sleeve 9 and its engagement with the main piece 4 and the other end connection being formed from the expanded sleeve 9 and its engagement with the container 3.

The fit peanut fitting 1 is, therefore, at least in two parts, the main piece 4 functioning as supporting holding part to the container 3 and the sleeve 9 designed as an internal, holding part provided with its double connection. With this construction, the fit peanut fitting 1 stably supports the connection tube 2 to the container 3 by the stop surface 8 (conformal with the container wall surface), while the deformed sleeve end portion 13 forms the connecting fixing of the main piece 4 at the container 3.

The main piece 4 can have different outer shapes, optionally a cylindrical outer surface, which can taper in direction of the container connection, or an outer shape in form of a truncated cone.

In FIG. 2 the sleeve 9 is formfittingly pushed into the fit passage 7, reaching into the container 3, before the projecting end portions 11, 13 are expanded. In FIG. 3 the end portions 11, 13 are expanded and deformed into tulip-shaped end portions 11′, 13′ that form the connections between the main piece 4 and the container 3.

In FIG. 4, the passage channel 10 located in the interior of the main piece 4 has the recess 22, and the fit passage 7 are structured as press fits, whereby the sleeve may press fit at 23 into the fit passage 7 or subsequently expanded into engagement and connection in the press fit region 23.

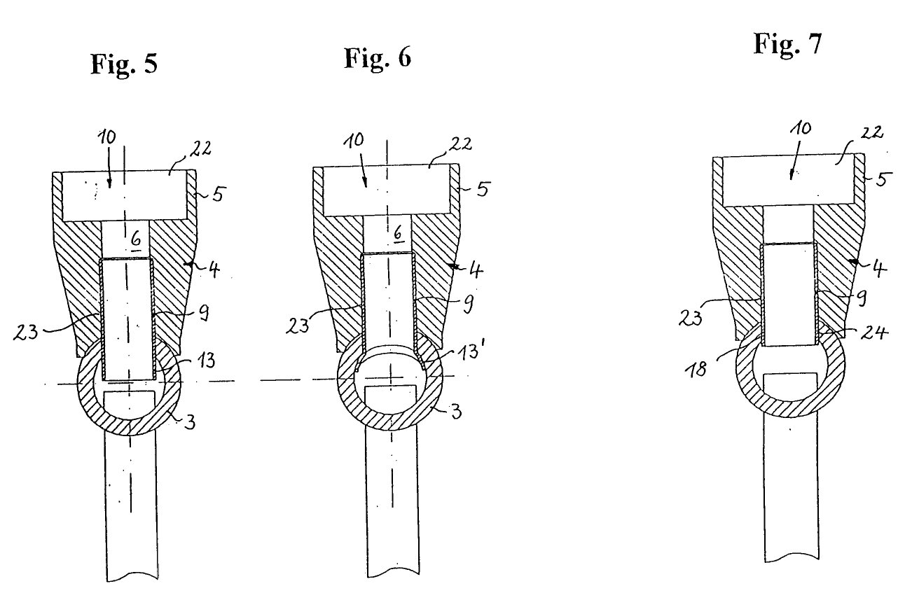

In FIGS. 5, 6 similar sectional view are shown of the main piece 4 with a sleeve 9 having the projecting end portion 13 reaching into the container 3 (FIG. 5) and the same sleeve 9 having the end portion 13′ deformed into a tulip-shape in the container 3 (FIG. 6). The sleeve 9 seats in the press fit 23 in an arresting press-fit connection, which is formed by pressing and/or expansion of the inserted sleeve 9.

In FIG. 7 a sectional view similar to FIG. 5 of the main piece 4 and is shown without the end portion of the sleeve 9 projecting very far into the container 3. The sleeve 9 is held deformed in a press-fit connection within the press fit 23 and a press fit 24 within the wall opening 18, so that both formfitting and force-transmitting connections exist.

In FIG. 8, the main piece 4 is formed with a unitary insertion portion in the form of an insert projection 9′ formed at the stop surface 8. The insert projection 9′ replaces the sleeve 9 in the interior of the main piece 4 and is a fixed portion of the main piece 4. In FIG. 9 in a sectional view the main piece 4 is shown with the formed insert projection 9′ press fit 24 in the wall opening 18.

The main piece 4 can also be connected to the container 3 in such a way that the insert projection 9′ (FIG. 9) or the sleeve end portion 13 (FIG. 7) is inserted into the wall opening 18 of the container 3 with the outer circumference of the insert projection 9′ or the end portion 13 of the sleeve 9 corresponding formfittingly to the wall opening 18 of the container 3. This is then force-transmittingly held by means of a press fit 24, or 23, respectively, and subsequently brazed.

In FIG. 10a, the sectional view shows the main piece 4 in a simple configuration. Herein, the seating portion 5 and the fit passage 7 with the closing concave stop surface 8 conformal with the container wall are all provided in a straight sided piece. An accompanying front view onto the seating portion 5 of the main piece 4 and the passage channel 10 is seen in FIG. 10b.

In FIG. 11 a sectional view shows the main piece 4 of FIG. 10 in combination with the container 3 and the connection tube 2. The main piece 4 seats the stop surface 8 at the container 3 and includes a sleeve 9 press fit 23 in the fit passage 7. The end portion 13′ of the sleeve 9 in the container 3 is expanded to form a tulip-shape at the inner wall 12 of the container 3. The inner diameter of the connection tube 2 is equivalent to the inner diameter of the pressed sleeve 9 in this case and is held press fit into the recess 22 of the seating portion 5. Between the end of the connection tube 2 and the entry into the fit passage 7, sealing elements can also be provided.

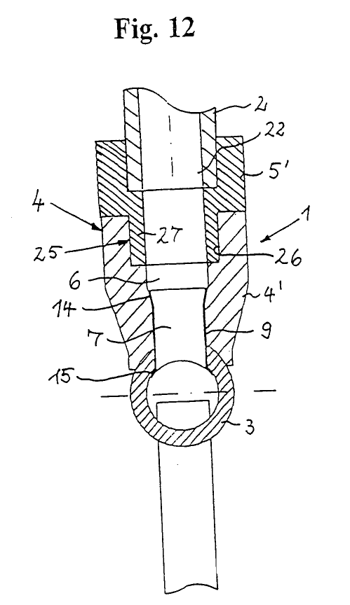

FIG. 12 shows a sectional view of the main piece 4, which is in two parts including a seating portion body 5′ and a main piece remaining body 4′. The connection region 25 between the seating portion body 5′ and the main piece remaining body 4′ can be formed by a seating opening 26 in the main piece remaining body 4′ and an insertion member 27 at the seating portion body 5′. Prior to the assembly of the fit peanut fitting 1, the connection tube 2 can be put into the recess 22 of the seating portion body 5′ and be firmly held there. The seating opening 26 can have the same dimensions as the recess 22. By means of a double connection 14, 15 (expanded ends to form a tulip-shape), the sleeve 9 fixes the main piece 4 and the container 3 prior to brazing. An even stronger connection of the connection region 25 can be achieved by mans of a screwing (not shown) between the seating portion body 5′ and the main piece remaining body 4′, particularly when the heat exchanger circuit is assembled, e.g., during the production of the vehicle. Alternatively, instead of the sleeve 9 also the main piece remaining body 4′ can be provided with the insert projection 9′ formed at it and have the same connections.

Referring back to FIG. 1, heat exchangers traditionally have flat tubes 16, with fins 11 located between the flat tubes 16, between two containers 3 on the sides, and to which at least one connection tube 2, as a feeding or draining tube, is attached.

For the assembly of the fit peanut fitting 1 as a holding connection element between the connection tube 2 and the container 3, the main piece 4 is put onto the container 3 so that the outlet opening 21 of the fit passage 7 corresponds to the existing wall opening 18 of the container 3. Following a previous insertion of the sleeve 9 into the fit passage 7 to such an extent that the end portion 13 projects over the stop surface 8, the projecting end portion 13 can be inserted into the wall opening 18 of the container 3. The sleeve 9 is then located in the fit passage 7 in such a way that the outer projecting end portion 13 of the sleeve projects into the container 3 and the opposite internal projecting end portion 11 of the sleeve projects into the intermediate chamber 6.

Fastening of the sleeve 9 can be carried out using an expansion tool. Whereby the sleeve 9 can be expanded by means of the inserted expansion tool and pressed onto the inner surface of the fit passage 7. Also by means of an expansion tool, both the first projecting end portion 11 directed to the intermediate chamber 6 and the second sleeve end portion 13 located in the interior of the container 3 projecting over the inner wall 12 can be deformed by expansion to a tulip-shaped end portions 11′, 13′. Thus it is possible to fasten the fit peanut fitting 1 at the container, e.g. header or tank, as well as at the container 3, which is rolled, formed or longitudinally welded from flat material to have the form of a container.

According to the invention, the sleeve 9 is provided as a connecting element in form of an insert bushing in order to fix the fit peanut fitting 1, particularly the main piece 4 and the container 3 to each other, prior to brazing.

The following illustrates just some possibilities of fixing the main piece 4: 1) simple expansion of the projecting end portions 11, 13 of the sleeve 9 to obtain a first press fit connection 14 between the sleeve 9 and the main piece 4 and a second press fit connection 15 between the sleeve 9 and the container 3; 2) expansion—beading, curling, flanging—of the second end portion 13, whereby the end portion of the sleeve 9 is pushed through the wall opening 18 into the container 3 to obtain after curling of the second end portion 13 a second socket 15 at the inner wall 12 of the container 3; and 3) in addition to expansion, the first end portion 11 of the sleeve 9 in the intermediate chamber 6 of the main piece 4 is also expanded to the tulip 11′, in order to obtain a first holding socket 14 in the intermediate chamber 6 of the main piece 4, whereby the intermediate chamber 6 of the 4 is shaped such that a connection between socket 14 and the interior of the main piece 4 can be created.

The sleeve 9 can optionally consist of a thin extruded tube, drawn tube or uncoated or braze-coated flat material—plates, flange—which can be formed to a sleeve 9 by round forming by an angle of less than 360° longitudinally open or by round forming by an angle of 360° longitudinally welded. Further, the sleeve 9 can designed as a deep-drawn component the shape of which, particularly both end portions, corresponds to the opening of the container 3 or the fit passage 7 of the fit peanut fitting 1. It is also possible to preform the socket 14 to the intermediate chamber 6 of the main piece 4 at the end portion 11 of the sleeve 9 prior to the assembly of the parts.

Further constructions of the assembly provide for the expansion of the sleeve 9 in the fit passage 7, or in the press fit 23, 24 and the forming of a tulip using a mandrel or an expansion nut can be used to achieve the press connections.

A tool can be used to expand the second end portion 13 in the interior of the container 3 this way forming the second socket 15 thus fastening the main piece 4 to the container 3. The tool is used outside of the heat exchanger. It can also be used to push the sleeve 9 into the main piece 4, to attach both to the container 3 and to expand the sleeve end portion 13 in the container 3 in order to be able to fasten the fit peanut fitting 1 to the container tube 3.

As another assembly step, brazing can be involved into the fit peanut fitting-container structure where only the direct stop surface 8 between the main piece 4 and the container 3 is brazed, whereby the sleeve 9 is provided for the purpose of common fixing the fit peanut fitting 1 and the container 3 during brazing or where the sleeve 9 can be coated with braze material before insertion, in order to feed sufficient braze material onto the stop surface 8 and the outer container wall surface 19 for brazing. In this way, the sleeve 9 is brazed to the main piece 4 and the container 3.

The insert projection 9′, which substantially corresponds to the second projecting end portion 13, can be treated as the second end portion 13 as far as container insertion and deformation are concerned.

Assembly of the sleeve 9 to a holding part is carried out such that the forming of a tulip-shaped or flanging of both projecting end portions 11, 13 of the sleeve 9 each to a socket 14, 15 at the fit peanut fitting and container sides is performed as double connection, in order to achieve stable fastening, at least before brazing.

From the above it is seen that the present invention enables a solution to the stated problem with minimal expense.

1. A fit peanut fitting for containers of heat exchangers and provided for the connection of the container to a connection tube for feeding or draining of a heat-transmitting, passing medium, the fitting comprising: a main piece and an accompanying insert portion, the main piece including a seating portion for the connection tube to be inserted thereinto in a matching manner and, on an opposite end, a stop surface being conformal with an outer wall surface of the container, the main piece also including a passage channel for the medium passing from the seating portion to the insert portion, the insert portion projecting over the stop surface such that at least a fixing connection to the wall opening of the container is achievable.

2. The fit peanut fitting of claim 1 wherein the insert portion is structured by means of a sleeve arrested in the passage channel.

3. The fit peanut fitting of claim 1 wherein the insert portion is formed projectingly at the stop surface.

4. The fit peanut fitting of claim 1 wherein the seating portion is provided with a recess for the end portion of the connection tube to be received therein.

5. The fit peanut fitting of claim 4 wherein the passage channel includes a fit passage portion extending from the recess to the stop surface.

6. The fit peanut fitting of claim 1 wherein the insert portion is structured as one of
a sleeve expanded on opposing ends in the main piece and in the container;
a sleeve press fit in the main piece and expanded on an end in the container;
a sleeve expanded on an end in the main piece and in a press fit in the container at the container wall opening;
an insert projection formed from the main piece and that is in a press fit at the container wall opening in the container; and
and insert projection formed from the main piece and that is expanded on an end at the container wall opening in the container.

7. The fit peanut fitting of claim 1 wherein the passage channel includes an intermediate chamber defined in the main piece between the seating portion and insert portion.

8. The fit peanut fitting of claim 6 wherein the passage channel includes a fit passage extending from an intermediate chamber in the main piece to the stop surface.

9. The fit peanut fitting of claim 6 wherein the intermediate chamber is provided with a taper directed to a fit passage of the channel passage.

10. The fit peanut fitting of claim 9 wherein an end portion of the sleeve is engaged against the taper of the intermediate chamber.

11. The fit peanut fitting of claim 1 wherein the passage channel includes a fit passage with a radially expanded portion in which a sleeve is located pressed in a press fit fastening.

12. The fit peanut fitting of claim 1 wherein the passage channel includes a fit passage and a sleeve having a length greater than that of the fit passage end portion of the sleeve projecting beyond the ends of the fit passage.

13. The fit peanut fitting of claim 12 wherein the end portions of the sleeve are engaged in one end connection between the sleeve and the main piece and are engaged in a second end connection between the sleeve and the container.

14. The fit peanut fitting of claim 12 wherein the sleeve is formfittingly received into the fit passage to form a force-transmitting press fit with the inner surface of the fit passage.

15. The fit peanut fitting of claim 1 wherein the insert portion includes a sleeve received therein that is coated with a braze coat on an exterior surface thereof.

16. The peanut fitting of claim 1 wherein the stop surface of the main piece is provided with a thin braze coat.

17. The fit peanut fitting of claim 1 wherein the insert portion includes a sleeve having a shape at its ends that corresponds to the wall opening of the container and having an outer diameter corresponding to an inner diameter of a fit passage portion of the channel passage.

18. The fit peanut fitting of claim 1 wherein the seating portion of the main piece is structured as a separate seating portion body and a remaining body, a connection region located between the seating portion body and the remaining body is provided with a seating opening and an insertion member formfittingly matching to the seating opening.

19. The fit peanut fitting of claim 18 wherein a supporting connection of the connection region is a threaded connection between the seating body and the remaining body.
